(19) United States
(12) Patent Application Publication
(10) Pub. No.: US 2017/0274769 A1
(43) Pub. Date: Sep. 28, 2017

(54) Audio and Visual Fuel Door Alarm

(71) Applicant: Jack Boon, Kalispell, MT (US)

(72) Inventor: Jack Boon, Kalispell, MT (US)

(21) Appl. No.: 15/080,824

(22) Filed: Mar. 25, 2016

(51) Int. Cl. B60K 28/12; G08B 7/06

(52) U.S. Cl. CPC B60K 28/12; G08B 7/06

(57) ABSTRACT

An audio and visual fuel door alarm for a vehicle fuel door comprises a sensor that is operationally coupled to the fuel door of a vehicle. A relay is operationally coupled to the sensor. A speaker and a light are operationally coupled to the relay. The sensor is configured to be activated upon opening of the fuel door of the vehicle. The relay is positioned to activate the speaker and the light should the ignition switch of the vehicle be engaged. The driver is provided an audio warning from the speaker and a visual warning from the light if the fuel door of the vehicle is in an open position when the vehicle is running.

### BACKGROUND OF THE DISCLOSURE

Field of the Disclosure

The disclosure relates to door alarms and more particularly pertains to a new door alarm with audio and visual warnings for a vehicle fuel door.

Summary of the Disclosure

An embodiment of the disclosure meets the needs presented above by generally comprising a sensor that is operationally coupled to the fuel door of a vehicle. A relay is operationally coupled to the sensor. A speaker and a light are operationally coupled to the relay. The sensor is configured to be activated upon opening of the fuel door of the vehicle. The relay is positioned to activate the speaker and the light should the ignition switch of the vehicle be engaged. The driver is provided an audio warning from the speaker and a visual warning from the light if the fuel door of the vehicle is in an open position when the vehicle is running.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an in-use view of an audio and visual fuel door alarm according to an embodiment of the disclosure.

FIG. 2 is a detail view of an embodiment of the disclosure.

FIG. 3 is a detail view of an embodiment of the disclosure.

FIG. 4 is a block diagram view of an embodiment of the disclosure.

### DESCRIPTION OF THE PREFERRED EMBODIMENT

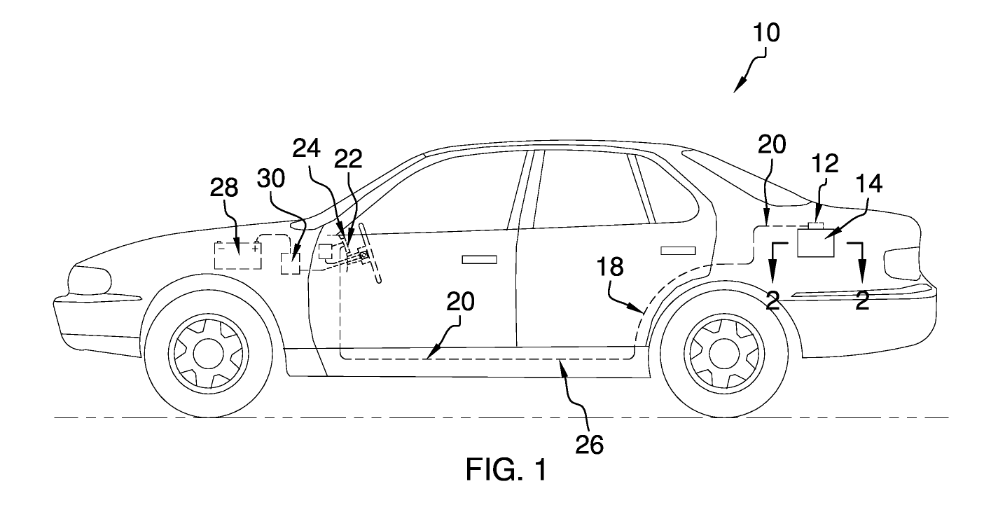

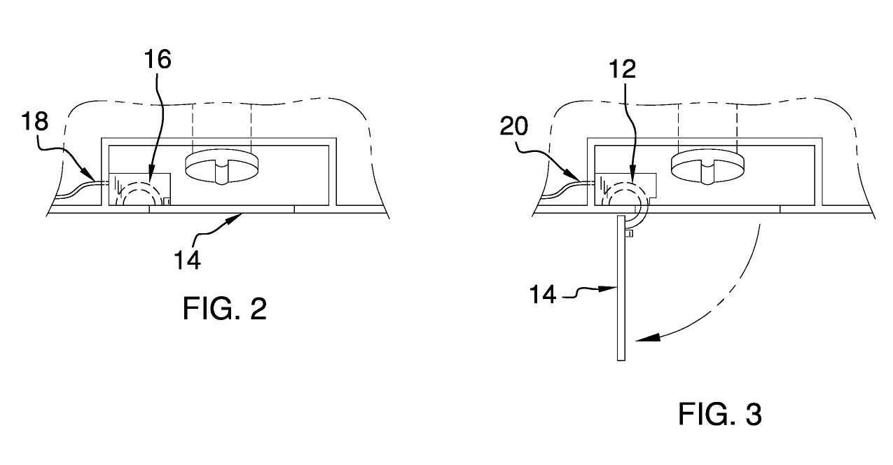

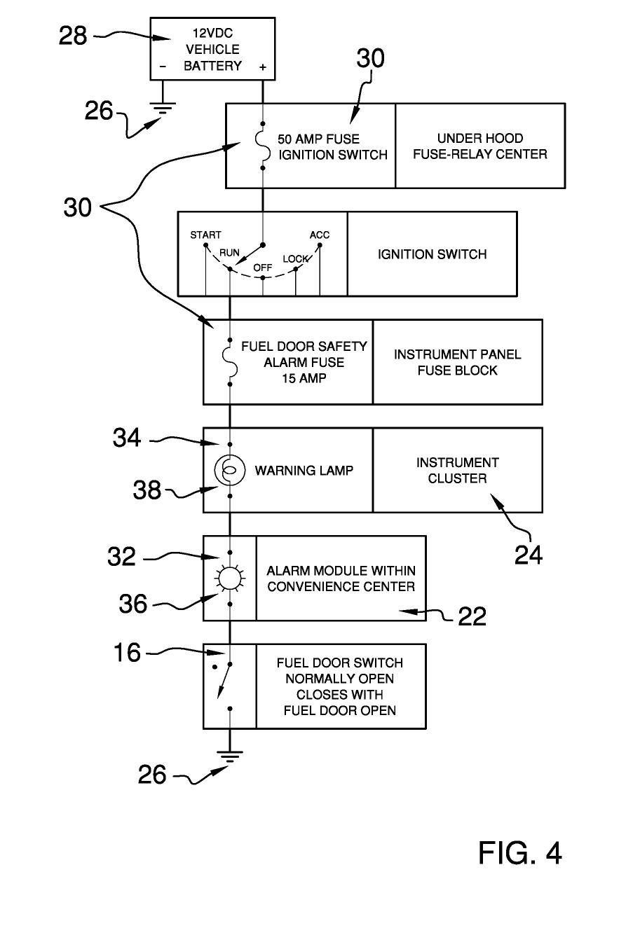

With reference now to the drawings, and in particular to FIGS. 1 through 4 thereof, a new door alarm embodying the principles and concepts of an embodiment of the disclosure and generally designated by the reference numeral 10 will be described.

As best illustrated in FIGS. 1 through 4, the audio and visual fuel door alarm 10 generally comprises a sensor 12 that is operationally coupled to the fuel door 14 of a vehicle. The sensor 12 may comprise a switch 16 that is coupled to the fuel door 14 of the vehicle, wherein the switch 16 is configured to close when the user opens the fuel door 14 of the vehicle. The switch 16 also may be coupled to the vehicle adjacent to the fuel door 14 of the vehicle, wherein the switch 16 is configured to close when the user opens the fuel door 14 of the vehicle.

A relay 18 is operationally coupled to the sensor 12. Preferably, the relay 18 comprises wiring 20 that extends from the switch 16 to a convenience center 22 and an instrument panel 24 of the vehicle. The wiring 20 is configured to complete a circuit 26 comprising the switch 16, the convenience center 22, the instrument panel 24, a battery 28, and respective fuses 30 of the vehicle when the switch 16 is closed.

The alarm 10 also comprises a speaker 32 and a light 34 that are positioned in the passenger compartment of the vehicle. The speaker 32 and the light 34 are operationally coupled to the relay 18. Preferably, the speaker 32 is positioned in the convenience center 22 of the vehicle and the light 34 is positioned in the instrument panel 24 of the vehicle. More preferably, the speaker 32 comprises the alarm speaker 36 of the vehicle and the light 34 comprises a warning light 38 of the vehicle.

In use, the sensor 12 is configured to be activated upon opening of the fuel door 14 of the vehicle. The relay 18 is positioned to activate the speaker 32 and the light 34 should the ignition switch of the vehicle be engaged. The driver is provided an audio warning from the speaker 32 and a visual warning from the light 34 should the fuel door 14 of the vehicle be in an open position when the vehicle is running.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An audio and visual fuel door alarm comprising:
a sensor, said sensor being operationally coupled to a fuel door of a vehicle;
a relay, said relay being operationally coupled to said sensor;
a speaker, said speaker being operationally coupled to said relay, said speaker being an alarm speaker of an existing alarm system of the vehicle; and
a light, said light being operationally coupled to said relay, wherein said sensor is configured to be activated upon opening of the fuel door of the vehicle, wherein said relay is positioned to activate said speaker and said light should an ignition switch of the vehicle be engaged, such that a user is provided an audio warning from said speaker and a visual warning from said light should the fuel door of the vehicle be in an open position when the vehicle is running.

2. The alarm of claim 1, further including said sensor comprising a switch, said switch being coupled to the fuel door of the vehicle, wherein said switch is configured to close when the user opens the fuel door of the vehicle.

3. The alarm of claim 1, further including said sensor comprising a switch, said switch being coupled to the vehicle adjacent to the fuel door of the vehicle, wherein said switch is configured to close when the user opens the fuel door of the vehicle.

4. The alarm of claim 2, further including said relay comprising wiring, said wiring extending from said switch to a position on the vehicle accessible to the user when the user is seated behind a wheel of the vehicle, and an instrument panel of the vehicle, wherein said wiring is configured to complete a circuit comprising said switch, the convenience center, the instrument panel, a battery, and respective fuses in the vehicle when said switch is closed.

5. The alarm of claim 1, further including said speaker being positioned in the passenger compartment of the vehicle.

6. The alarm of claim 4, further including said speaker being positioned in the position on the vehicle accessible to the user when the user is seated behind the wheel of the vehicle.

7. (canceled)

8. The alarm of claim 1, further including said light being positioned in the passenger compartment of the vehicle.

9. The alarm of claim 4, further including said light being positioned in the instrument panel of the vehicle.

10. The alarm of claim 9, further including said light comprising a warning light of the vehicle.

11. An audio and visual fuel door alarm comprising:
a sensor, said sensor being operationally coupled to a fuel door of a vehicle, said sensor comprising a switch, said switch being coupled to the fuel door of the vehicle, wherein said switch is configured to close when a user opens the fuel door of the vehicle, said switch being coupled to the vehicle adjacent to the fuel door of the vehicle, wherein said switch is configured to close when the user opens the fuel door of the vehicle;
a relay, said relay being operationally coupled to said sensor, said relay comprising wiring, said wiring extending from said switch to a position on the vehicle accessible to the user when the user is seated behind a wheel of the vehicle, and an instrument panel of the vehicle, wherein said wiring is configured to complete a circuit comprising said switch, the position on the vehicle accessible to the user when the user is seated behind the wheel of the vehicle, the instrument panel, a battery, and respective fuses in the vehicle when said switch is closed;
a speaker, said speaker being positioned in the passenger compartment of the vehicle, said speaker being operationally coupled to said relay, said speaker being positioned in the convenience center of the vehicle, said speaker comprising the alarm speaker of the vehicle; and
a light, said light being positioned in the passenger compartment of the vehicle, said light being operationally coupled to said relay, said light being positioned in the instrument panel of the vehicle, said light comprising a warning light of the vehicle;
wherein said sensor is configured to be activated upon opening of the fuel door of the vehicle, wherein said relay is positioned to activate said speaker and said light should an ignition switch of the vehicle be engaged, such that the user is provided an audio warning from said speaker and a visual warning from said light should the fuel door of the vehicle be in an open position when the vehicle is running.
